(19) United States
(12) Patent Application Publication
(10) Pub. No.: US 2010/0198459 A1
(43) Pub. Date: Aug. 5, 2010

(54) In-vehicle communications apparatus

(75) Inventors: Jun Kosai, Nisshin-city (JP); Kazuoki Matsugatani, Kariya-city (JP); Shugo Kato, Kitanagoya-city (JP); Toshiya Saito, Hekinan-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/654,474

(22) Filed: Dec. 22, 2009

(30) Foreign Application Priority Data
Feb. 3, 2009 (JP) 2009-22804

(51) Int. Cl. G06F 19/00

(52) U.S. Cl. 701/36

(57) ABSTRACT

Application data generated by an ECU is wireless transmitted by a transmission device in a subject vehicle so as to periodically change a communications distance by changing, every transmission timing, at least one of (i) a transmission rate, which is used in transforming a transmission packet into a transmission signal in a modulation section, and (ii) a transmission power, which is configured by an amplification section to amplify the transmission signal. As a result, the data transmission from the subject vehicle can be made (i) in high repetition times with respect to a nearby vehicle having a greater risk of collision (i.e., time to collision being shorter), and (ii) in low repetition times with respect to a distant vehicle having a less risk of collision (i.e., time to collision being longer).

### CROSS REFERENCE TO RELATED APPLICATION

The present application is based on and incorporates herein by reference Japanese Patent Application No. 2009-22804 filed on Feb. 3, 2009.

### FIELD OF THE INVENTION

The present invention relates to an in-vehicle communications apparatus used for a wireless communication system in which several communications terminals execute broadcast type data transmission via a common wireless channel.

### BACKGROUND OF THE INVENTION

[Patent document 1] JP-2004-343467 A

[Patent document 2] JP-2007-6395 A

[Patent document 3] JP-2008-227797 A

[Non-patent Document 1] Advanced Safety Vehicle (ASV) Promotion Planning Report, Regarding activity results in 3rd term ASV plan, (March, 2006 (Heisei 18)) The Ministry of Land, Infrastructure and Transport Road Transport Bureau, Advanced Safety Vehicle Promotion Investigative Commission, Page 75

In recent years, there is developed a wireless communications system in which inter-vehicle (vehicle-to-vehicle) communications is performed between in-vehicle communication terminals so as to exchange travel information of vehicles. The purpose of the wireless communications system is as follows. That is, each vehicle can recognize a position, speed, etc. of peripheral another vehicle, thereby helping prevent a rear-end collision or head-on collision and facilitating a traffic flow.

It is noted that in the wireless communications system, each vehicle performs communications while moving or traveling, thus momentarily undergoing the change in communications environment. The density of the number of vehicles sometimes differs greatly in between the different communications environments like between the urban area and mountain area. In such different communications environments, the optimal transmission parameters (transmission power, transmission rate, transmission cycle, etc.) should differ.

That is, for example, it is better to set up transmission power high in order to realize communications with a distant vehicle; however, if all the vehicles communicate with the fixed high transmission power, the communications interference is apt to easily arise. In addition, the density of vehicles is often high near intersections or congested areas. If the same transmission power as that used in the area having the low density of vehicles is used, the communications interference may increase, thereby allowing only the inefficient communications.

Then, in order to address such a disadvantage, the following (1) to (4) are proposed conventionally.

(1) Increasing the transmission power as the speed of the subject vehicle increases (for example, refer to Patent document 1). According to such a technology, when the density of vehicles is high like at the time of the traffic congestion, the information can reach only a short distance; at the time of the high speed traveling, the information can reach a long distance, thus controlling the transmission power depending on the change of the density of vehicle.

(2) Predicting a relative distance between the subject vehicle and a communications partner after a predetermined time, and controlling the transmission power based on the predicted relative distance (for example, refer to Patent document 2). According to such a technology, the transmission power is controllable to meet the sufficient electric power required to send the information to the communications partner or vehicle. This helps prevent the radio wave from reaching or covering a long distance unnecessarily, thus reducing the radio wave interference.

(3) Controlling the transmission power and the transmission cycle based on travel environments (width of street, weather, etc.) which affects the speed of the subject vehicle and the density of vehicles around the subject vehicle (for example, refer to Patent document 3). According to such a technology, the transmission power and the transmission cycle can be controlled in response to the change of the communications environment. Such changes are exemplified by traffic congestion versus normal travel, or urban area versus mountain area. Thus, the radio wave interference can be reduced.

(4) Controlling the transmission cycle according to the speed of the subject vehicle (for example, recited in Nonpatent document 1). According to such a technology, the communications traffic amount is reducible, while maintaining the required information update interval.

In this regard, however, all the above mentioned technologies set the transmission power or transmission cycle to a fixed value according to the control condition specified by the speed etc. Further, the broadcasting type communications provide the data transmission for many unspecified communications terminals. As a result, it may be difficult to provide a secured safety at the time of vehicle traveling or to, sufficiently reduce the radio wave interference, thus posing a disadvantage.

That is, in Patent document 1, the transmission power is controlled depending on the speed so that at low speed traveling, the information reaches only a short distance while at high speed traveling, the information reaches a long distance. However, in order to realize communications outside of the sight even at low speed traveling in an actual environment, it is necessary to communicate using the large electric power. As a result, the safety at the traveling of the vehicle cannot be secured enough. In addition, it is unnecessary to always transmit the information to a long distance even at high speed traveling; further, transmitting always the large electric power at high speed traveling poses the radio wave interference.

In addition, the technology given in Patent document 2 controls the electric power according to relative distance with the communications partner; thus, it is difficult to apply it to the broadcasting type communications, which should have unfixed communications partners.

In addition, in Patent document 3, the transmission power and the transmission cycle are controlled using the travel speed and travel environment; at high speed traveling, the information reaches a vehicle in a long distance and a vehicle in a short distance, in the same high repetition times of transmission. In this regard, however, when the use for the safety is considered, it is unnecessary to transmit the information to the vehicle in a long distance in high repetition times; thus, unnecessary radio wave interference may be generated.

In addition, in Nonpatent document 1, the transmission cycle is controlled depending on the travel speed at high speed traveling of the vehicle, the information reaches a vehicle in a long distance and a vehicle in a short distance in the same high repetition times of transmission, similar in Patent document 3; thus, unnecessary radio wave interference may be generated.

### SUMMARY OF THE INVENTION

The present invention is made in view of the disadvantage mentioned above. It is an object to provide an in-vehicle communications apparatus executing broadcast type data transmission and securing the safety in traveling by means of the data communications between the vehicles while suppressing the increase in the communications traffic amount due to unnecessary data transmission to thereby reduce the generation of radio wave interference.

To achieve the above object, according to an example of the present invention, an in-vehicle communications apparatus in a vehicle is provided as follows. The in-vehicle communications apparatus is one of a plurality of communications apparatuses used for a wireless communications system in which the plurality of apparatuses execute broadcast type wireless data transmission with each other via a common wireless channel. The in-vehicle communications apparatus comprises a transmission unit and a transmission control circuit. The transmission unit is configured to perform a wireless transmission of transmission data by transforming the transmission data into a wireless transmission signal. The transmission control circuit is configured to periodically vary a communications distance of the transmission data by controlling a transmission parameter, which is used when the transmission unit performs the wireless transmission by transforming the transmission data into the wireless transmission signal.

According to the above configuration, the data transmission can be made in high repetition times with respect to a vehicle in a short distance from the subject vehicle; the data transmission can be made in low repetition times with respect to a vehicle in a long distance from the subject vehicle.

A conventional apparatus sets the transmission power (correlated with a communications distance) or transmission cycle to a predetermined fixed value according to a control condition such as a vehicle speed. Thus, compared with the conventional one, the in-vehicle communication apparatus according to the aspect of the present invention can secure the safety in vehicle traveling, and reduce the communications traffic amount of the wireless communications of the whole system, resulting in helping prevent the radio wave interference from arising.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram illustrating a configuration of an in-vehicle communications apparatus according to a first embodiment of the present invention;

FIG. 2 is a diagram illustrating a control information list used in the first embodiment;

FIG. 3 is a flowchart illustrating a process executed by a transmission control circuit according to the first embodiment;

FIGS. 4A, 4B are diagrams explaining changes in communications distance due to transmission control according to the first embodiment;

FIG. 5 is a block diagram illustrating a configuration of an in-vehicle communications apparatus according to a first modification of the first embodiment;

FIG. 6 is a diagram illustrating a control information list used in the first modification of the first embodiment;

FIG. 7 is a block diagram illustrating a configuration of an in-vehicle communications apparatus according to a second modification of the first embodiment;

FIG. 8 is a block diagram illustrating a configuration of an in-vehicle communications apparatus according to a third modification of the first embodiment;

FIG. 9 is a block diagram illustrating a configuration of an in-vehicle communications apparatus according to a second embodiment of the present invention;

FIG. 10 is a diagram illustrating a control information list used in the second embodiment;

FIG. 11 is a flowchart illustrating a process executed by a transmission control circuit according to the second embodiment;

FIG. 12 is a diagram illustrating changes in communications distance due to transmission control according to the second embodiment;

FIG. 13 is a diagram illustrating a simulation model used for evaluating an effect of the second embodiment;

FIG. 14A is a diagram illustrating changes in communications distance in Prior Art as a comparative example;

FIG. 14B is a diagram illustrating changes in communications distance in a simulation model according to the second embodiment;

FIG. 15A is a diagram illustrating a simulation result of the number of reception packets per unit time in a receiving vehicle at high speed traveling;

FIG. 15B is a diagram illustrating a simulation result of the number of reception packets per unit time in a receiving vehicle at low speed traveling;

FIG. 16A is a diagram illustrating a simulation result of an information update interval versus time to collision at high speed traveling;

FIG. 16B is a diagram illustrating a simulation result of an information update interval versus time to collision at low speed traveling;

FIG. 17A is a block diagram illustrating an operation at high speed traveling according to a first modification of the second embodiment;

FIG. 17B is a block diagram illustrating an operation at low speed traveling according to the first modification of the second embodiment;

FIG. 18 is a block diagram illustrating a configuration of an in-vehicle communications apparatus according to a third embodiment of the present invention;

FIG. 19 is a diagram illustrating a control information list used in the third embodiment;

FIG. 20 is a flowchart illustrating a process executed by a transmission control circuit according to the third embodiment; and

FIG. 21 is a diagram illustrating a control information list used in a first modification of the third embodiment.

### DETAILED DESCRIPTION OF THE PREFERRED EMBODIMENTS

Hereafter, description will be given to embodiments of the present invention with reference to the drawings.

### First Embodiment

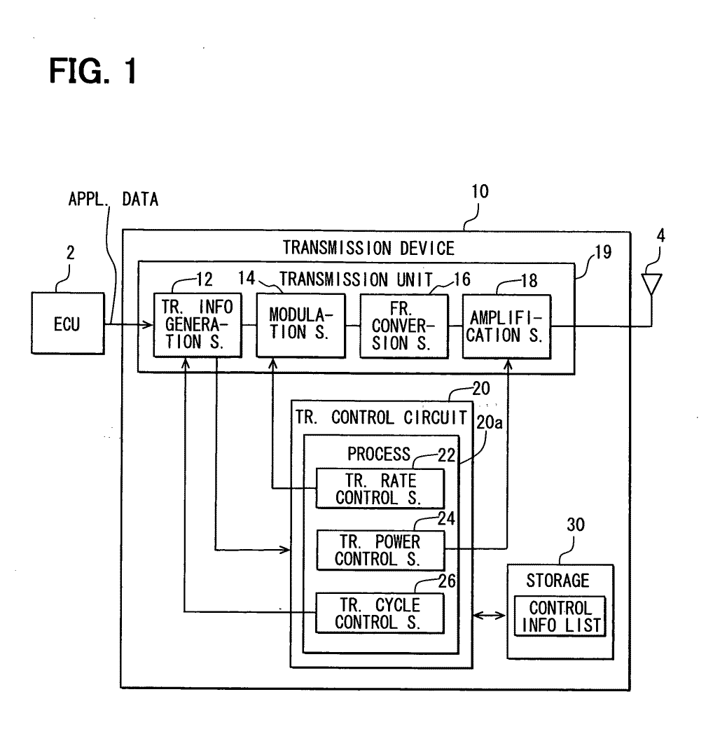

FIG. 1 is a block diagram illustrating a configuration of a transmission device 10 of an in-vehicle communications apparatus, which is mounted in a subject vehicle, of a first embodiment according to the present invention.

As illustrated in FIG. 1, the transmission device 10 includes the following: a transmission information generation section 12 to acquire application data as transmit data (i.e., transmission data) from at least one (single or several) electronic control section (ECU) 2 which is mounted in the subject vehicle, and to generate packet data (transmission packet) for transmission or communications; a modulation section 14 to transform the transmission packet, which is generated in the transmission information generation section 12, into a transmission signal according to a predetermined transmission rate; a frequency conversion section 16 to perform a frequency conversion from the transmission signal outputted by the modulation section 14 to a high-frequency signal for wireless transmission or communications; and an amplification section 18 to amplify the transmission signal, which undergoes the frequency conversion in the frequency conversion section 16, so as to provide a predetermined transmission power, thereby wirelessly transmitting the amplified transmission signal via an antenna 4. Further, the transmission information generation section 12, the modulation section 14, and the amplification section 18 are collectively referred to as a transmission unit or circuit 19.

In addition, the transmission device 10 further includes a transmission control circuit 20 in addition to the above transmission unit 19. The transmission control circuit 20 controls, with respect to application data, (i) a transmission cycle, (ii) a transmission rate, and (iii) a transmission power, by controlling the transmission information generation section 12, the modulation section 14, and the amplification section 18, respectively.

Further, the transmission control circuit 20 includes (i) a transmission cycle control section 26 to control the transmission cycle of application data by controlling the output timing of the transmission packet from the transmission information generation section 12 to the modulation section 14; (ii) a transmission rate control section 22 to set up a transmission rate used when the modulation section 14 transforms the transmission packet into the transmission signal; and (iii) a transmission power control section 24 to set up a transmission power of the transmission signal wirelessly transmitted by the amplification section 18 via the antenna 4.

In addition, while the transmission control circuit 20 controls as parameters the transmission cycle, transmission rate, and transmission power at the time of transmitting application data by the operations of the respective sections 22, 24, 26, the control information on those parameters is stored in a storage section 30 as a control information list.

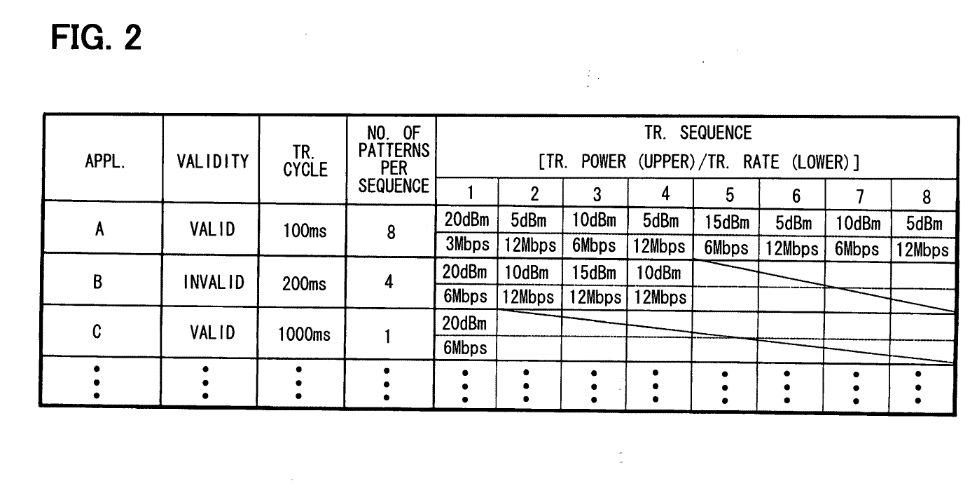

As illustrated in FIG. 2, the control information list contains the following descriptions or specifications with respect to each of types (A, B, C, . . . ) of the application data (i.e., application data elements) inputted to the transmission information generation section 12 from the ECU 2, (i.e., every type of an application software program generating the application data). The descriptions for every type of the application data include a transmission cycle which corresponds to a transmission timing or time point, the number of patterns per single transmission sequence to change the communications distance at each transmission time point (in other words, it can be equivalent to the number of transmission time points included in a single transmission sequence), and control data (i.e., the transmission power and transmission rate in the present embodiment) for changing the communications distance at each of the transmission time points included in the single transmission sequence. In addition, the transmission control circuit 20 can describe in the control information list a flag for indicating the validity (i.e., either valid or invalid) of the respective application data.

For example, with respect to the application (data element) A, the transmission cycle is 100 ms, the number of patterns per (single) transmission sequence is eight. That is, eight patterns take place in order within the single transmission sequence as follows: the first packet is transmitted at the first transmission time point or timing in the transmission power of 20 dBm and the transmission rate of 3 Mbps; the second packet is transmitted at the second transmission time point or timing in the transmission power of 5 dBm and the transmission rate of 12 Mbps; the third packet is transmitted at the third transmission time point or timing in the transmission power of 10 dBm and the transmission rate of 6 Mbps; and, subsequently, each of the following fourth to eighth packets is transmitted at each of the fourth to eighth transmission time points or timing in the transmission power and the transmission rate respectively illustrated in FIG. 2, thereby completing the transmission sequence up to the eighth packet or pattern and then returning to the first pattern of the next transmission sequence.

As explained above, the control information is set up or designated depending on the type of the application data. In cases that application data elements generated by the different application software program are inputted into the transmission information generation section 12, such different application data elements can be transmitted in optimal transmission cycles, respectively. In addition, it can be configured that the ECU 2 executes several application software programs simultaneously.

Furthermore, in FIG. 2, the application (data or data element) C has only a single pattern per single transmission sequence; thus, the application C is always transmitted in the same transmission parameter.

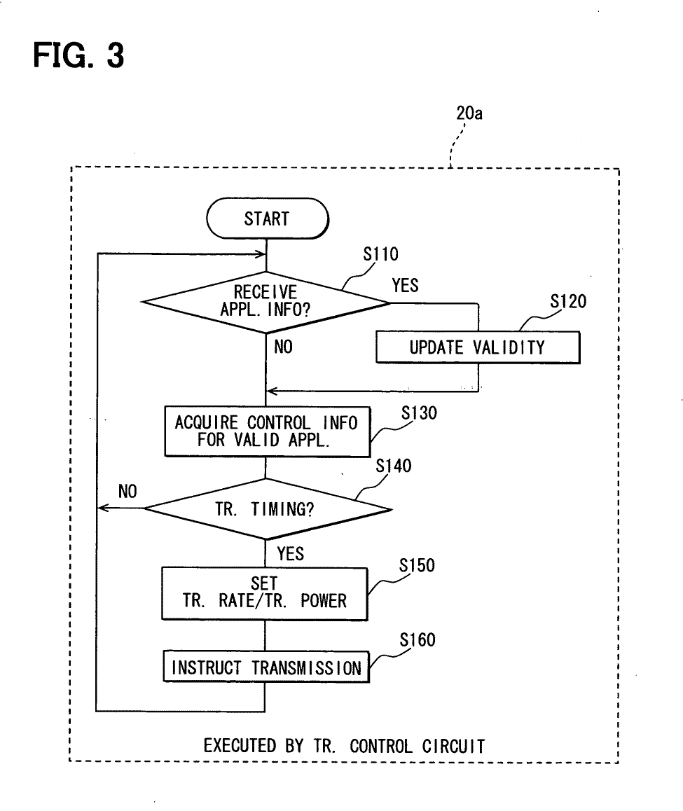

FIG. 3 is a flowchart illustrating a process or operation executed by the transmission control circuit 20. It is noted that the process 20a or processing illustrated in FIG. 3 is repeatedly executed by a microcomputer included in the transmission control circuit 20. The functions as the transmission rate control section 22, the transmission power control section 24, and the transmission cycle control section 26 are achieved by the microcomputer executing the process in FIG. 3.

It is further noted that a flowchart or the processing of the flowchart in the present application includes sections (also referred to as steps), which are represented, for instance, as S110. Further, each section can be divided into several sub-sections while several sections can be combined into a single section. Furthermore, each of thus configured sections can be referred to as a means or unit and achieved not only as a software device but also as a hardware device.

Returning to FIG. 3, at S110 (as explained above, representing Section 110 or Step 110), the transmission control circuit 20 first determines whether to receive from the transmission information generation section 12 the application information, which indicates whether each application data described in the control information list is valid or invalid at the present time.

That is, the transmission information generation section 12 monitors an update timing inputted from the ECU 2 for every application data (or application data element). If the application data is not updated for a certain predetermined period, it is determined that the application data is invalid, thus reporting it to the transmission control circuit 20. If the application data is updated within the certain predetermined period, it is determined that the application data is valid, thus reporting it to the transmission control circuit 20. That is, at S110, it is determined whether the validity (i.e., valid or invalid) of the application data has been reported or not.

When it is determined at S110 that the application information is received, the processing advances to S120. At S120, the flag in the control information list stored in the storage section 30 is set or reset based on the received application information to thereby update the validity being either valid or invalid with respect to the application data stored in the storage section 30. The processing then advances to S130. When it is determined at S110 that the application information is not received, the processing directly advances to S130.

At S130, the transmission control circuit 20 acquires control information relative to the application data being valid from the control information list stored in the storage section 30.

At S140, it is determined whether there are any application data which is presently at the transmission time point or timing based on the acquired control information. When there is no application data presently at the transmission time point, the processing advances to S110. It is noted that the processing at S140 may function as the transmission cycle control section 26.

In contrast, when it is determined at S140 that there is application data presently at the transmission time point, the processing advances to S150. At S150, from the control information acquired at S130, the transmission rate and transmission power corresponding to the present transmission time point are read out; thus, the read transmission rate and the read transmission power are provided (i.e., set) to the modulation section 14 and the amplification section 18, respectively. It is noted that the processing at S150 may function as the transmission rate control section 22 and transmission power control section 24.

At S160, the transmission information generation section 12 is instructed to transmit the application data presently at the transmission time point. The processing then returns to S110.

Furthermore, when instructed to transmit the application data by the transmission control circuit 20, the transmission information generation section 12 selects the corresponding application data from among the application data acquired from ECU 2 and transforms the selected one into the transmission packet to thereby output to the modulation section 14. Accordingly, the modulation section 14 transforms the transmission packet into the transmission signal based on or using the transmission rate set up by the transmission control circuit 20.

Further, the transmission signal undergoes the frequency conversion in the frequency conversion section 16 and then is inputted to the amplification section 18, which amplifies the inputted transmission signal having undergone the frequency conversion. The amplification section 18 amplifies the inputted transmission signal such that the transmission power outputted via the antenna 4 turns into the transmission power set up by the transmission control circuit 20. Therefore, the communications distance of the application data is determined depending on the transmission rate and transmission power which are described in the control information list. The communications distance corresponds to a communications range which the radio wave transmitted from the antenna 4 can reach.

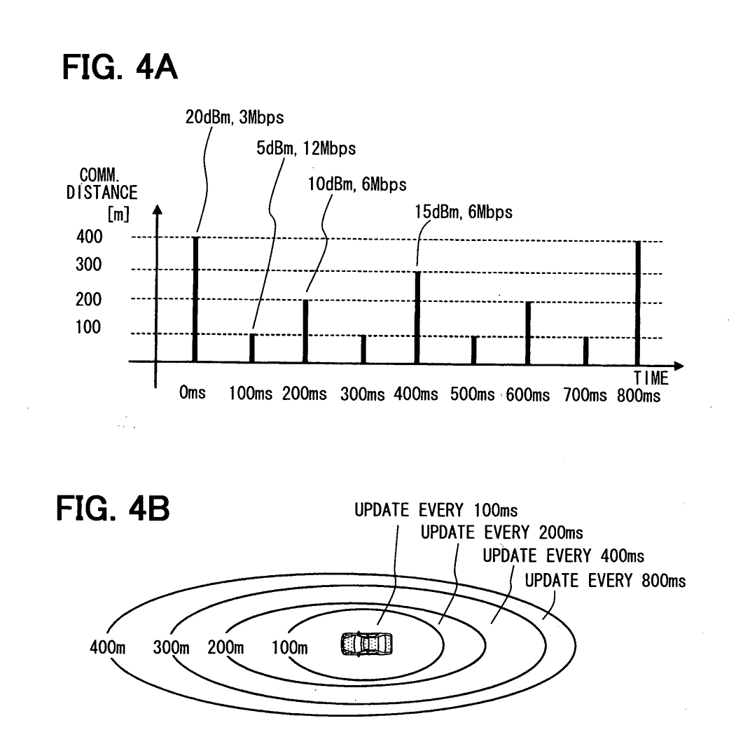

That is, the transmission rate and transmission power vary periodically based on the transmission cycle and the change pattern, both of which are set up with respect to each application data; thus, the communications distance of the each application data changes periodically, as exemplified in FIG. 4A. Furthermore, FIG. 4A illustrates the time series variation of the communications distance of the application data A.

FIG. 4B illustrates a relation of the communications distances and receptions or updates of the transmission data, which is the application A, for instance. Within the range of 100 m from the subject vehicle as a transmitting vehicle, the transmission data is receivable every 100 ms; within the range of 100 m to 200 m from the transmitting vehicle, the transmission data is receivable every 200 ms; within the range of 200 m to 300 m from the transmitting vehicle, the transmission data is receivable every 400 ms; and within the range of 300 m to 400 m from the transmitting vehicle, the transmission data is receivable every 800 ms.

Under such a configuration of the present embodiment, by changing periodically the transmission power and the transmission rate of the application data, the data can be transmitted in high repetition times to a nearby vehicle with a greater risk of collision (i.e., with time to collision being shorter); the data can be transmitted in low repetition times to a distant vehicle with a less risk of collision (i.e., with time to collision being longer).

In other words, with respect to the transmission data being application data for safety, while securing the safety during the vehicle traveling, the repetition times of the unnecessary transmission to a long distance can be decreased, thus helping prevent radio wave interference from arising uselessly. In addition, with respect to the transmission data for other applications such as traffic flow facilitation, information can be exchanged with nearby vehicles in high repetition times, thus allowing more accurate recognition of the surrounding traffic situation.

In the present embodiment, as explained above, the transmission information generation section 12, the modulation section 14, the frequency conversion section 16, and the amplification section 18 can be collectively referred to as a transmission unit or circuit 19. The transmission control circuit 20 can be referred to as a transmission control means. The storage section 30 can be referred to as a storage means or section.

(First Modification)

In the above explained present first embodiment, the transmission cycle for every application data is described in the control information list, and the transmission control circuit 20 transmits each application data element periodically based on the described transmission cycle. Without need to be limited thereto, the transmission timing of the application data can be taken as the input timing of the application data from the ECU 2 to the transmit information generation section 12; namely, at the input timing of each application data element, the transmission control circuit 20 can set up the transmission rate and transmission power of the modulation section 14 and the amplification section 18, respectively.

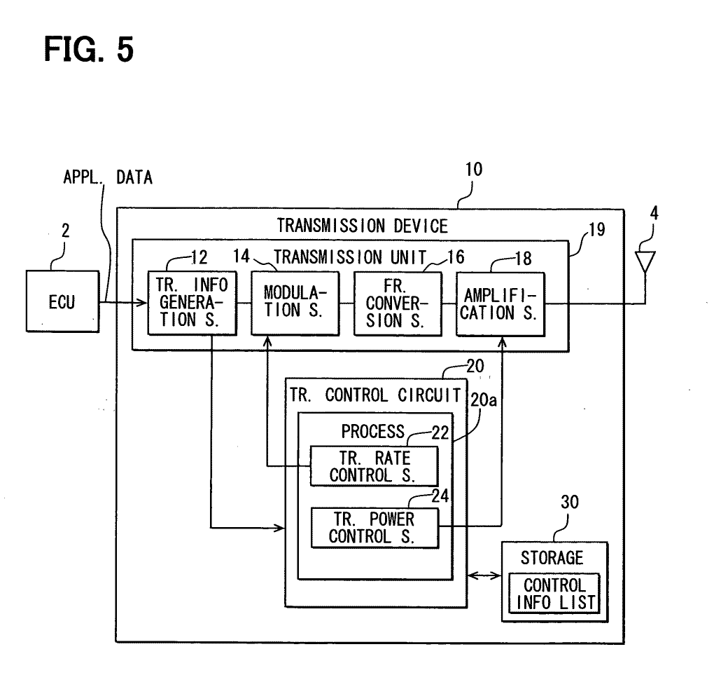

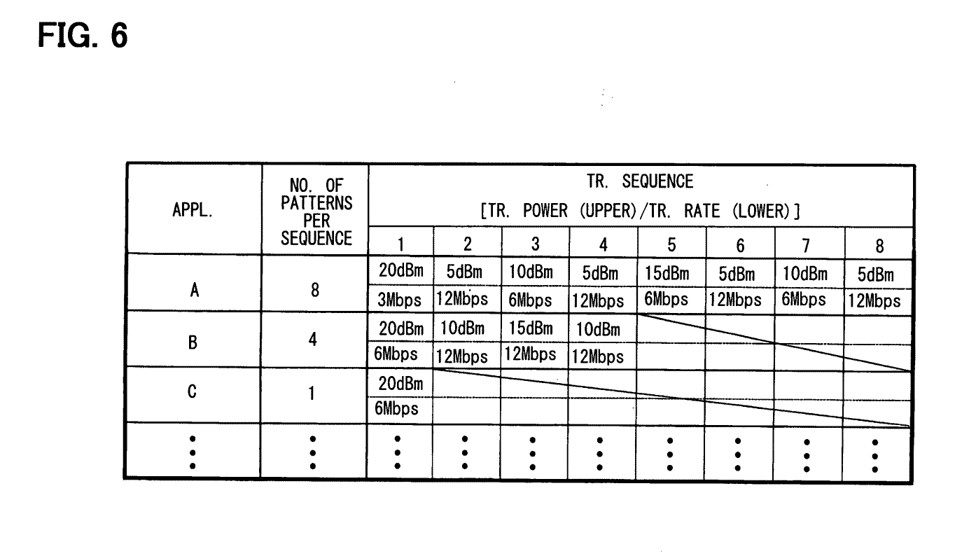

Such a configuration can eliminate the function of the transmission cycle control section 26, resulting in the configuration illustrated in FIG. 5. In addition, as illustrated in FIG. 6, the corresponding control information list describes, with respect to each application or each application data element, the number of patterns per transmission sequence, and the transmission power and the transmission rate at each transmission time point or timing, thus providing simplicity compared with the control information list illustrated in FIG. 2.

The actual operation of the transmission device 10 can take place upon receiving the application data inputted from the ECU 2 as follows. The transmission information generation section 12 is caused to report the type of the inputted application data to the transmission control circuit 20; the transmission control circuit 20 then refers to the control information list to thereby cause the modulation section 14 and the amplification section 18 to set up the transmission rate and transmission power, respectively, at the present transmission timing of the application data.

(Second Modification)

In the present first embodiment and the above first modification thereof, the transmission control circuit 20 refers to the control information list stored in the storage section 30 in order to set up the transmission rate and transmission power. Without need to be limited thereto, those transmission parameters such as transmission rate and transmission power may be set up by the ECU 2 generating the application data.

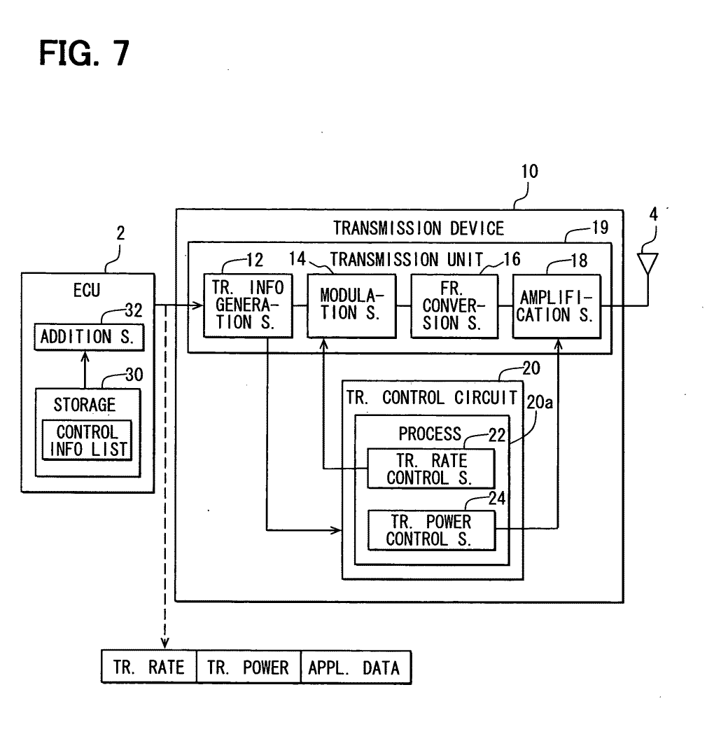

To that end, as illustrated in FIG. 7, for example, the ECU 2 includes a storage section 30 for storing the control information list, and a transmission control information addition section 32 for adding the transmission rate and transmission power to the application data according to the contents of the control information list stored in the storage section 30. In contrast, upon receiving the application data inputted from the ECU 2 via the transmission information generation section 12, the transmission control circuit 20 reads the transmission rate and transmission power, which are added to the application data, and causes the modulation section 14 and the amplification section 18 to set those respective parameters. In such a case, the transmission control circuit 20 or a combination of the transmission rate control section 22 and transmission power control section 24 may function as a transmission parameter control means or section.

In such a configuration, depending on the application software program executed by the ECU 2, the transmission rate and transmission power of the application data transmitted to other vehicles can be set up.

Furthermore, in FIG. 7, the transmission control information addition section 32 can be referred to as a control information addition means or section and the transmission control circuit 20 can function as or include a transmission parameter control means or section.

(Third Modification)

In the above explanation, the transmission packet outputted from the transmission information generation section 12 is transformed into the transmission signal in the modulation section 14. It is noted that the present embodiment is used for a wireless communications system in which several communications terminals or apparatuses execute broadcast type data transmission via a common wireless channel; thus, the modulation section 14 confirms, through or with carrier sensing (method), that the wireless channel is vacant, thereby starting the transmission of the transmission packet (that is, transformation to the transmission signal).

Further, it may be a case that a determination level of determining a carrier sense used for determining the state of vacancy is fixed. Such a case may involve a disadvantageous situation as follows. For instance, (i) although the necessary communications distance is short, the transmission radio wave is received from a vehicle located in a long distance from the subject vehicle, thereby prohibiting the data transmission. (ii) In contrast, when the necessary communications distance is long, the transmission radio wave having possibility of interfering with the transmission radio wave from the subject vehicle is transmitted from a vehicle located in a long distance; the radio wave from the vehicle in the long distance is not detected. Thereby, the execution of the data transmission from the subject vehicle is started.

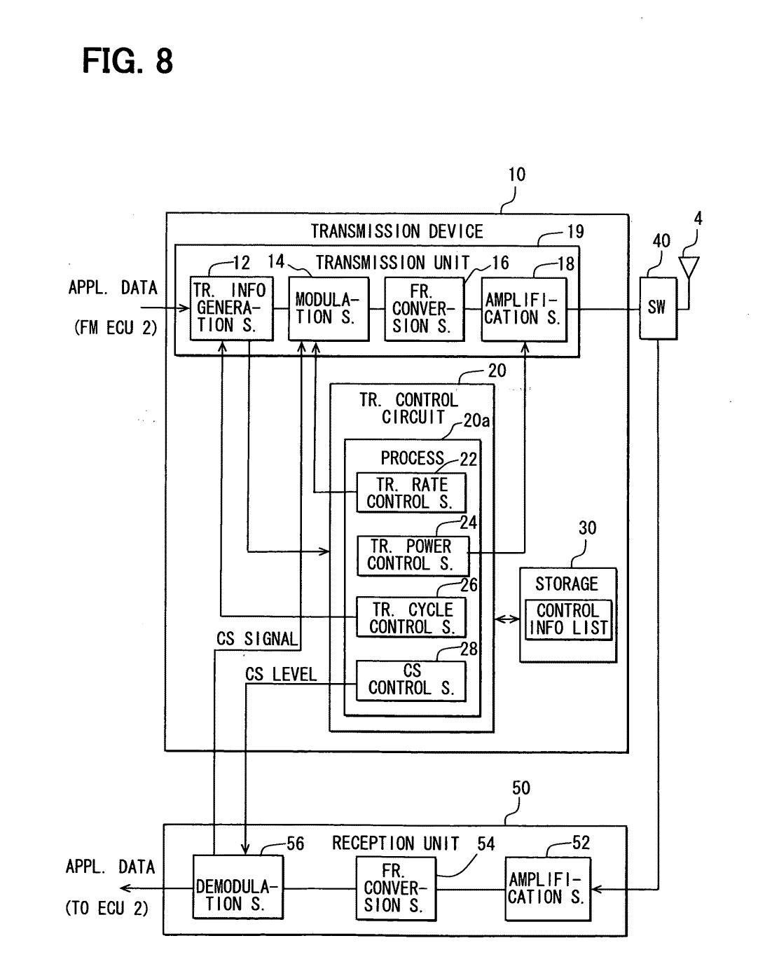

To prevent such a disadvantage from occurring, as illustrated in FIG. 8, the transmission control circuit 20 may desirably include a CS control section 28 to set up a CS level depending on the communications distance of the application data. In other words, the CS level can be set up such that as the communications distance is shorter, the CS level becomes higher.

That is, the in-vehicle communications apparatus usually includes a reception unit 50 for receiving a transmission radio wave from other vehicles and a reception/transmission switching section 40. Via the reception/transmission switching section 40, while the transmission signal from the transmission device 10 is outputted to the antenna 4, the reception signal received by the antenna 4 is inputted to the reception unit 50.

Further, the reception unit 50 includes the following: an amplification section 52 for amplifying reception signals; a frequency conversion section 54 for performing a frequency conversion of the reception signal to an intermediate frequency band (or baseband); and a demodulation section 56 for demodulating the received data (application data) from the reception signal having undergone the frequency conversion in the frequency conversion section 54. The demodulation section 56 determines whether the signal level of the reception signal reaches a predetermined CS level, to thereby determine whether the transmission radio wave is arriving from another in-vehicle communications apparatus (i.e., the wireless channel (or radio channel) is vacant or not).

In addition, when the radio channel is used by another in-vehicle communications apparatus, the demodulation section 56 generates a carrier sense signal (CS signal), which indicates that the radio channel is currently used, to the modulation section 14. In contrast, when the CS signal is not inputted from the demodulation section 56 (i.e., when the radio channel is vacant), the modulation section 14 starts transmitting the transmission data (application data) by converting the transmission packet to the transmission signal.

Further, as illustrated in FIG. 8, in the in-vehicle communication apparatus, the transmission control circuit 20 includes a CS control section 28, which sets up the CS level used for the carrier sensing of the demodulation section 56 depending on the communications distance of the application data. Such a configuration allows the prompt transmission of the application data to be executed within a range where the inter-vehicle communications is prevented from suffering from bad influence because of the radio wave interference between the transmission radio wave from another vehicle and the transmission radio wave from the subject vehicle.

Furthermore, in the in-vehicle communications apparatus illustrated in FIG. 8, the reception unit 50 may function as a reception means or section; the CS control section may function as a determination value control means or section.

(Fourth Modification)

In the above explanation, both the transmission rate and the transmission power are changed to change a communications distance every transmission timing of the application data. Without need to be limited thereto, only either the transmission power or the transmission rate can be changed.

In addition, in FIG. 4A, the change of patterns relative to the communications distance is described as fluctuating up and down one pattern-by-one pattern in a time basis of the transmission sequence. Without need to be limited thereto, the change of patterns relative to the communications distance may be defined as increasing or decreasing gradually one pattern-by-one pattern from a reference timing in a time basis of the transmission sequence.

In addition, otherwise, the change relative to the communications distance may occur randomly in a time basis of the transmission sequence. It is noted that the change of the patterns illustrated in FIG. 4A can provide a desirable one. It is because the pattern corresponding to the short distance communications is inserted so as to interpolate the pattern corresponding to the long distance communications, thereby transmitting the information at almost equal intervals independent of the distance from a vehicle transmitting the data.

### Second Embodiment

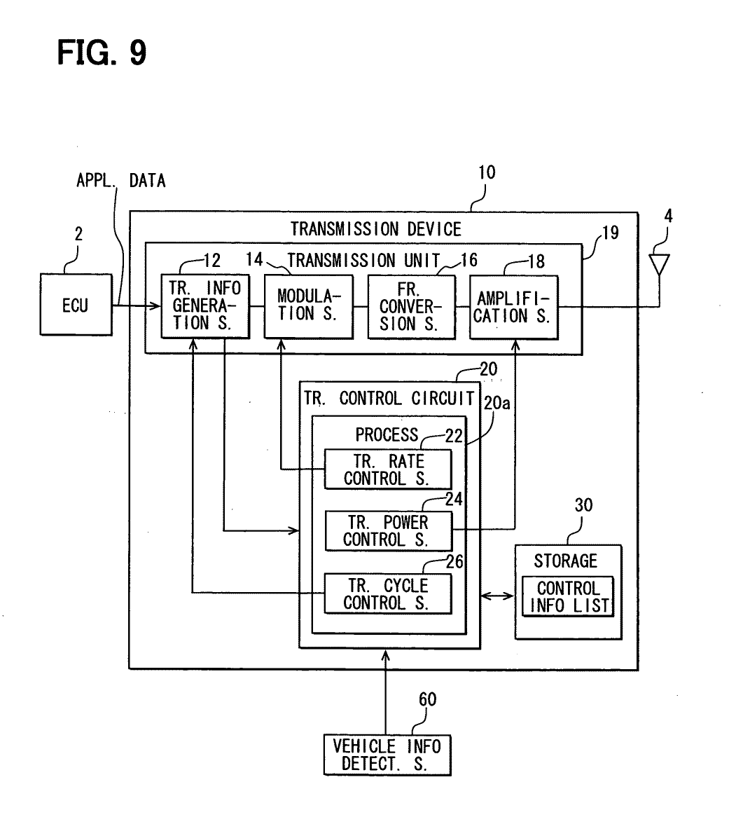

Next, FIG. 9 is a block diagram illustrating a configuration of an in-vehicle communications apparatus mounted in a subject vehicle, according to a second embodiment of the present invention.

The in-vehicle communications apparatus of the present second embodiment has almost the same configuration as that of the in-vehicle communications apparatus of the first embodiment illustrated in FIG. 1. The different point from the first embodiment is in that the second embodiment includes a subject vehicle information detection section 60 to detect a travel speed and present position of the subject vehicle. For instance, the subject vehicle information detection section 60 includes a GPS (Global Positioning System) receiver.

In the second embodiment, a transmission control circuit 20 executes almost the same operation as that in the first embodiment. The detailed explanation about common portions is thus omitted in the following explanation; the different portions are only explained on priority basis.

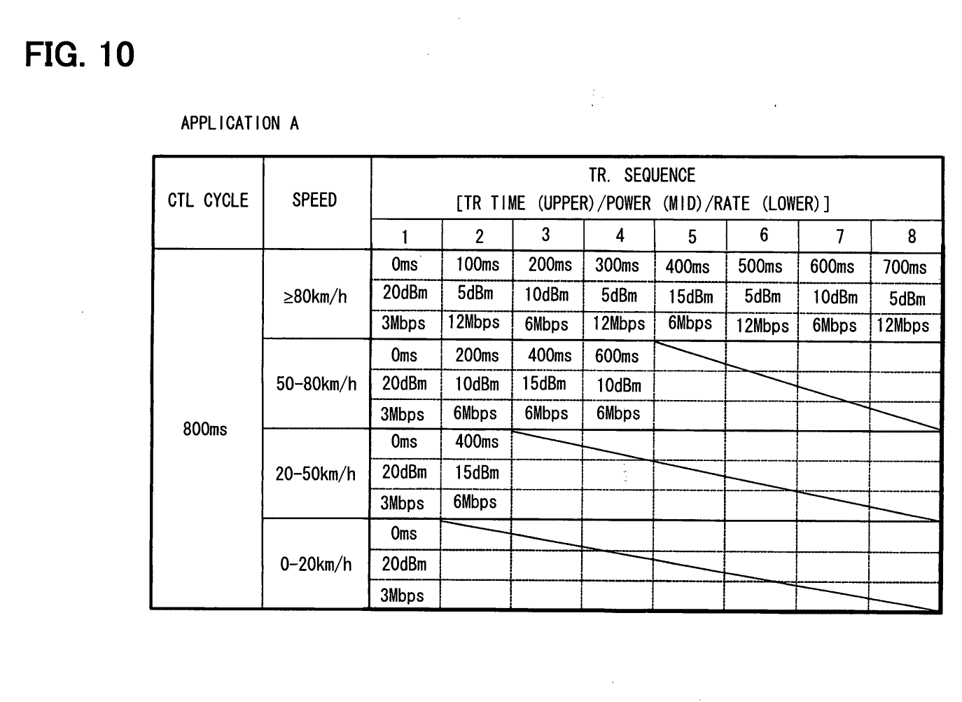

First, a control information list is stored in the storage section 30 for every application data element as a transmission target element like in the first embodiment. In this regard, however, as illustrated in FIG. 10, the control information list for every application data element of the second embodiment is designed so as to update the change of the patterns relative to the communications distance based on the speeds detected by the subject vehicle information detection section 60. That is, for instance, with respect to the application data element A in FIG. 10, the control information list includes, in each of several speed ranges, several control information items, each of which includes a transmission time point or timing and a transmission rate and power in the transmission timing.

That is, a control cycle or one sequence cycle (e.g., 800 ms with respect to application data element A illustrated in FIG. 10) is defined as one cycle in which the communications distance is changed based on the change of the patterns. For example, a certain reference timing is assigned with 0 ms. It is assumed that the subject vehicle runs at 60 km/h. In such cases, at the timing of 0 ms, the data element is transmitted in the transmission power of 20 dBm and the transmission rate of 3 Mbps; at the timing of 200 ms, the data element is transmitted in the transmission power of 10 dBm and the transmission rate of 6 Mbps; at the timing of 400 ms, the data element is transmitted in the transmission power of 15 dBm and the transmission rate of 6 Mbps; at the timing of 600 ms, the data element is transmitted in the transmission power of 10 dBm and the transmission rate of 6 Mbps; and at the timing of 800 ms, returning to the reference timing of 0 ms, the data element is transmitted in the transmission power of 20 dBm and the transmission rate of 3 Mbps.

It is noted that as the speed is increased, the transmission repetition times per single control cycle (i.e., per single transmission sequence) is increased. Further, the transmission rate and transmission power are set such that at each of the transmission time points or timing, which are added in response to the increase of the repetition times, the communications distance becomes short compared with that at the lower speed.

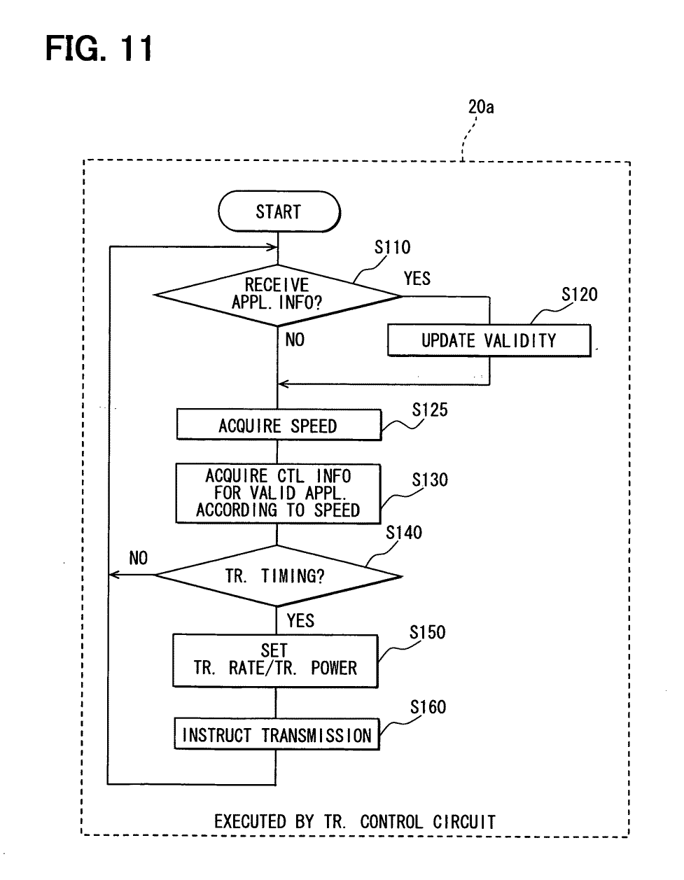

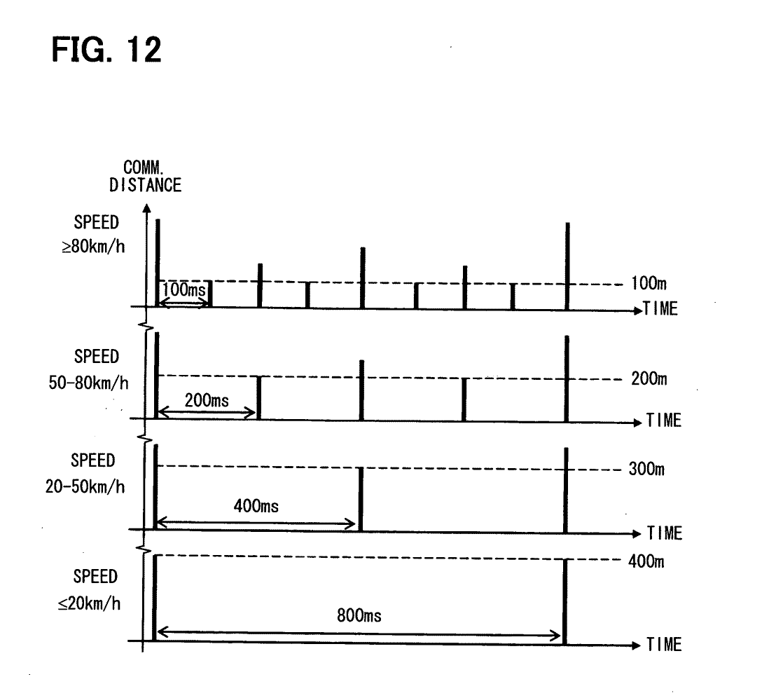

Furthermore, FIG. 11 illustrates a flowchart of an operation executed by the transmission control circuit 20 according to the second embodiment. The portion different from that of FIG. 3 of the first embodiment is in that (i) before acquiring the control information at S130, the transmission control circuit 20 acquires a speed from the subject vehicle information detection section 60 at S125; and (ii) at S130, when acquiring the control information relative to the application data being valid from the control information list stored in the storage section 30, the transmission control circuit 20 acquires the control information corresponding to the speed acquired at S125.

Thus, the transmission control circuit 20 executes the transmission control of the application data element A using the control information list illustrated in FIG. 10. That is, when the subject vehicle runs at not less than 80 km/h, providing that the subject vehicle is centered, the data reaches vehicles within a communications range of 0 to 100 m at time intervals of 100 ms; the data reaches vehicles within a communications range of 100 to 200 m at time intervals of 200 ms; the data reaches vehicles within a communications range of 200 to 300 m at time intervals of 400 ms; and the data reaches vehicles within a communications range of 300 to 400 m at time intervals of 800 ms.

The above is the same operation of that of the first embodiment; in contrast, when the speed is decreased, the operation is changed as follows.

For instance, when the subject vehicle runs at 40 km/h, provided that the subject vehicle is centered, the data reaches vehicles within a communications range of 0 to 300 m at time intervals of 400 ms; and the data reaches vehicles within a communications range of 300 to 400 m at time intervals of 800 ms. The repetition times the data reach peripheral vehicles are decreased. Even if a vehicle is present within a communications range of 0 to 200 m, the data can reach the vehicle only at time intervals of 400 ms.

There seems to be disadvantageous in respect of the safety. However, at the low speed, even if a distance to a nearby vehicle is shorter, the time up to collision is longer, not degrading the safety in addition, while the safety is thus maintained, the transmission amount is decreased, reducing the communications traffic amount compared with the first embodiment.

Furthermore, in the present embodiment, the subject vehicle information detection section 60 can be also referred to as a subject vehicle information acquisition means or section.

(Simulation for Confirming Effect)

Next, in order to investigate an effect of the present embodiment quantitatively, a simple simulation is made in comparison with a conventional technology (transmission cycle control technique) described in Nonpatent document 1 mentioned above.

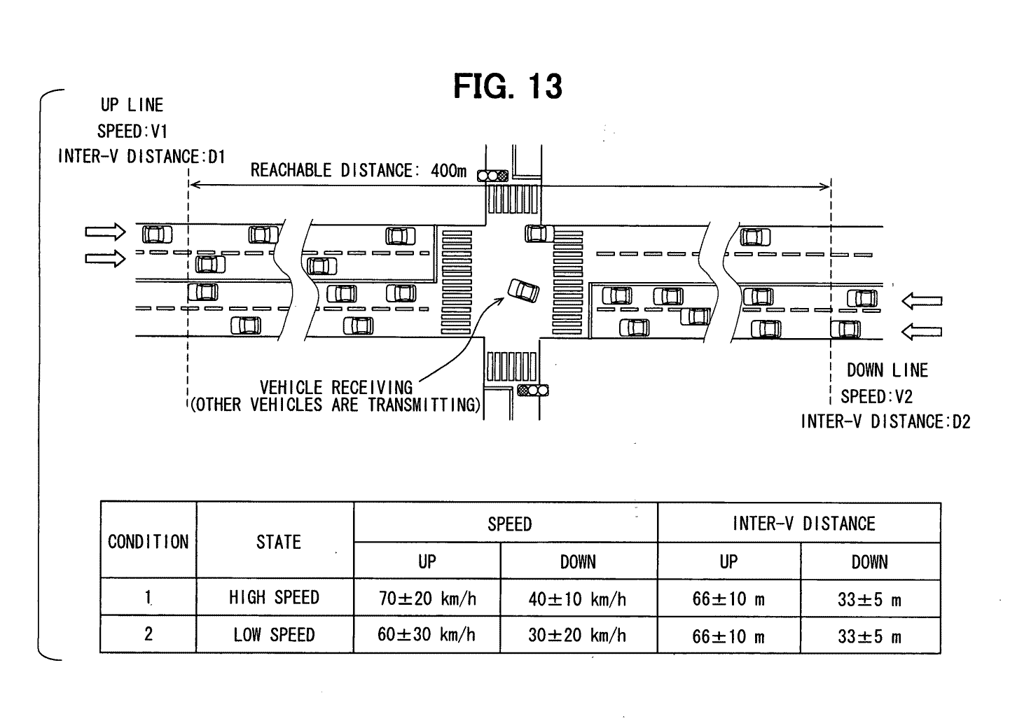

FIG. 13 illustrates a simulation model in which several vehicles mounted with in-vehicle communications apparatuses travel in two lanes of an up line direction and two lanes of a down line direction.

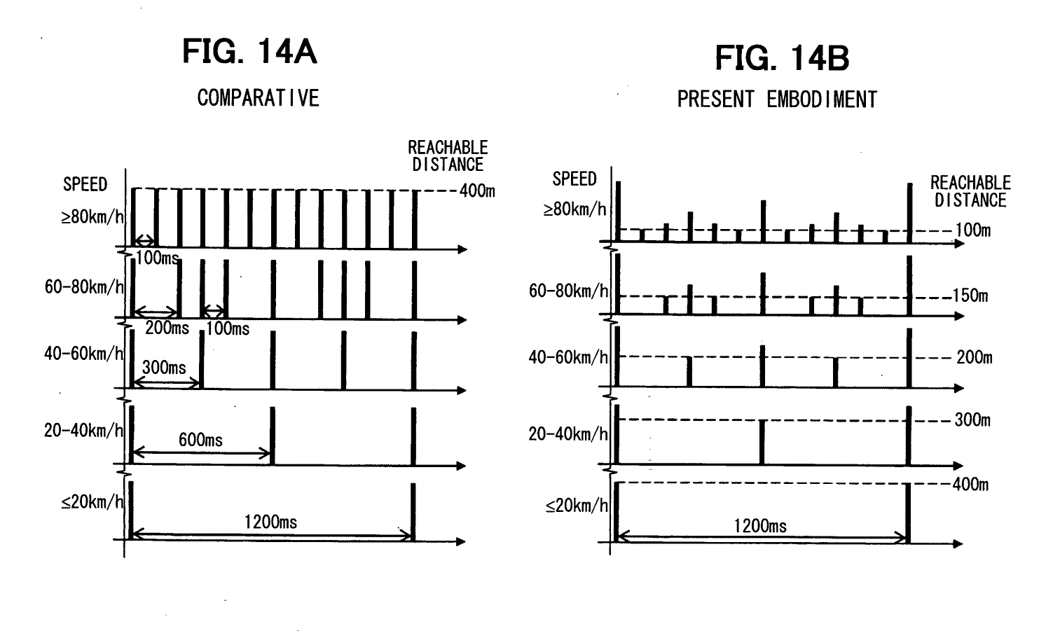

As illustrated in FIGS. 14A, 14B, with respect to in-vehicle communications apparatuses, the present embodiment controls the transmission cycle and transmission distance depending on speeds; a comparative example as a conventional technology controls only the transmission cycle depending on speeds while fixing the transmission distance (i.e., the transmission rate and transmission power).

In addition, the simulation condition includes two types of a high speed traveling and a low speed traveling of the subject vehicle while the speeds and inter-vehicle distances are set as indicated in the lower columns in FIG. 13.

Further, the premise is set such that a reception vehicle that receives transmission data is located at a center of the intersection. Transmission vehicles that transmit data are defined as vehicles other than the reception vehicle. Herein, an evaluation is made in how many packets the reception vehicle receives from other peripheral transmission vehicles and how frequent (i.e., what an update time interval) the data is updated.

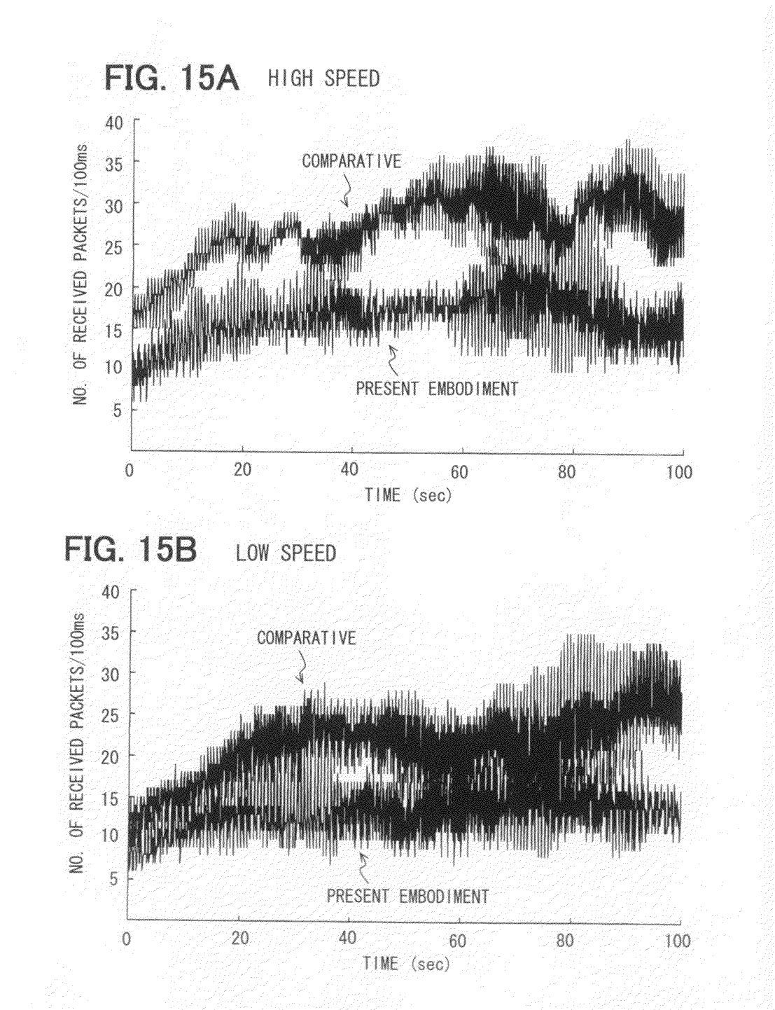

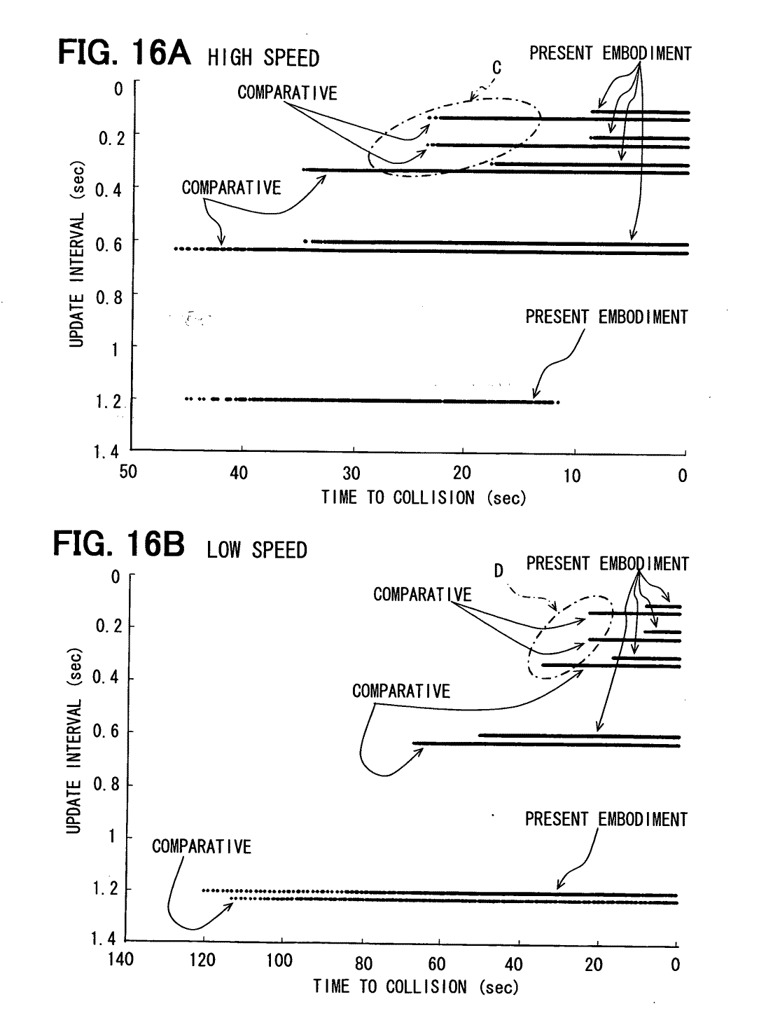

FIGS. 15A, 15B, 16A, and 16B illustrate simulation results. FIGS. 15A, 15B illustrate the number of reception packets per 100 ms in the reception vehicle versus time (i.e., a time-basis variations of reception packets) at the high speed traveling (condition) and the low speed traveling (condition). FIGS. 16A, 16B illustrate a relation between a time to collision and information update time interval at the high speed traveling condition and the low speed traveling condition.

FIGS. 15A, 15B explicitly exhibit the following: the number of reception packets in the comparative example is greater than that of the present embodiment, thus causing more communications traffic amounts in the comparative example.

Further, FIGS. 16A, 16B exhibit the following. In the comparative example, even when the time to collision is long (equal to or greater than 10 sec), the information is updated at the very short intervals (e.g., portions C and D indicated by the alternate long and short dash line in FIGS. 16A, 16B. In the present embodiment, as the time to collision becomes longer, the information update interval becomes longer compared with the comparative example. In addition, in the present embodiment, when the time to collision is short, the information update interval does not become longer than the comparative example. It can be said that the safety is not degraded.

Under such a configuration of the present embodiment, the communications traffic amount can be reduced, without degrading the safety during the traveling of the vehicle compared with the conventional technology recited in the description of Nonpatent document 1.

(First Modification)

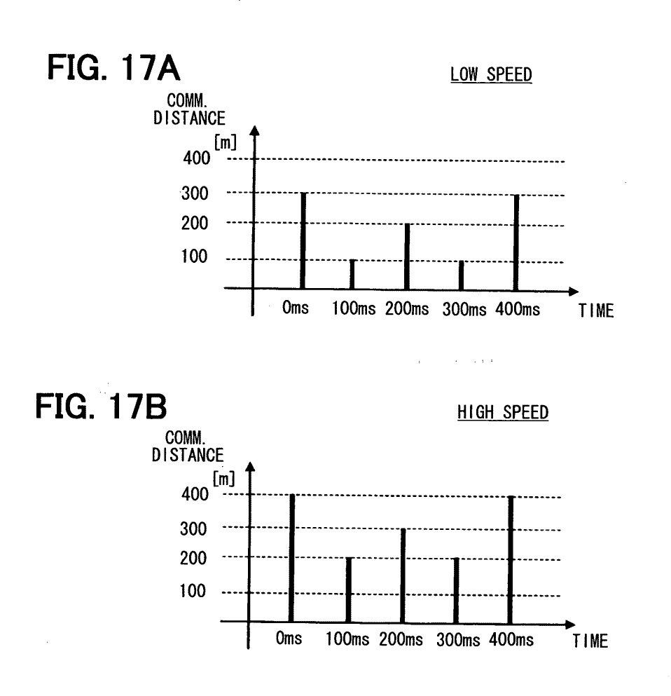

In the present second embodiment, the control patterns for changing the communications distance periodically is varied depending on the speed of the vehicle. Further, for example, the control patterns for changing the communications distance periodically is made as illustrated in FIGS. 17A, 17B. That is, as the speed of the vehicle varies, the transmission time points or timing are maintained in the same while the communications distance is varied.

In detail, the transmission rate and transmission power in each transmission time point are changed depending on the speed of the vehicle such that the communications distance in each transmission time point at high speed traveling condition is longer than that at low speed traveling condition.

Under such a configuration, the data can be transmitted at high speed traveling condition farther than that at low speed traveling condition. This can raise the safety at high speed traveling condition.

In addition, the third modification or the fourth modification of the first embodiment can be applied to the present second embodiment, thereby providing the similar effect.

### Third Embodiment

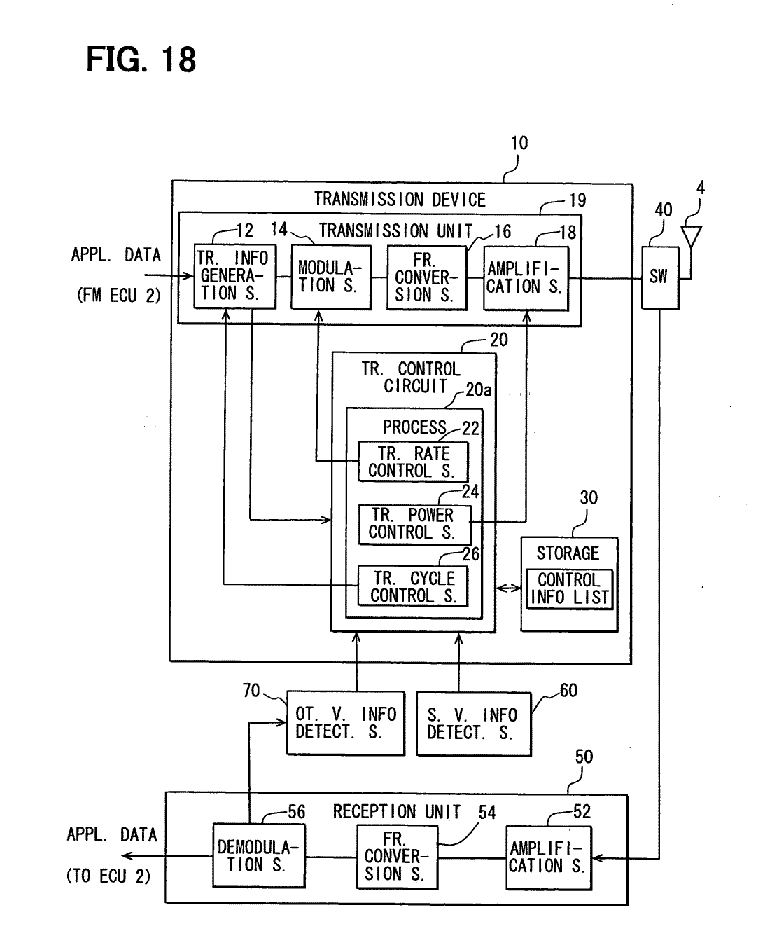

Next, FIG. 18 is a block diagram illustrating a configuration of an in-vehicle communications apparatus according to a third embodiment of the present invention.

The in-vehicle communications apparatus of the present embodiment has almost the same configuration as that of the in-vehicle communications apparatus of the third modification of the first embodiment illustrated in FIG. 8. The different point is in that the present third embodiment further includes a subject vehicle information detection section 60 for detecting a travel speed and present position of the subject vehicle, and an other vehicle information detection section 70.

The other vehicle information detection section 70 is to extract other vehicle information for indicating a travel speed and present position of another vehicle out of transmission data (application data) from peripheral vehicles. Such transmission data are demodulated by the demodulation section 56 of the reception unit 50.

Furthermore, in the present embodiment, the CS signal is inputted into the modulation section 14 from the demodulation section 56 of the reception unit 50 like the in-vehicle communications apparatus illustrated in FIG. 8. In the present embodiment, the explanation of the carrier sensing etc. is omitted; thus, in FIG. 18, neither the CS signal nor the CS control section 28 are described.

The present third embodiment includes a transmission control circuit 20 executing a process almost similar to that of the second embodiment. Detailed explanation is mainly made with respect to different portions therebetween.

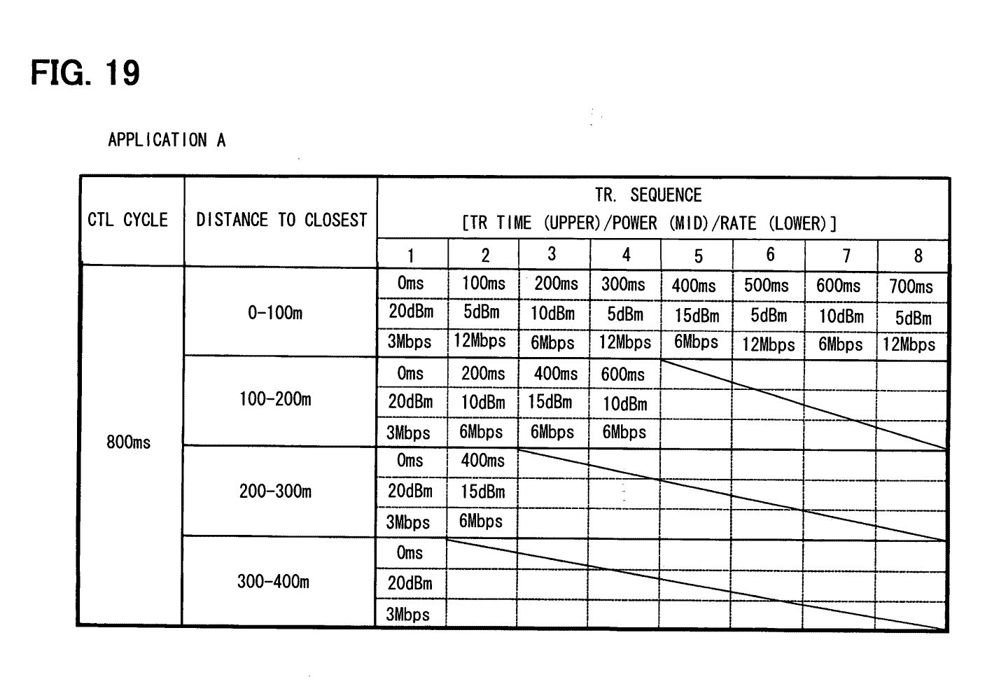

First, a control information list is stored in the storage section 30 for every application data element as a transmission target element like in the first and second embodiments. In this regard, however, the control information list includes, in each of several communications distance ranges, several control information items within a control cycle (i.e., single transmission sequence), as illustrated in FIG. 19. This is for the purpose of changing the patterns of communications distance depending on a distance between the subject vehicle and a peripheral vehicle (the closest vehicle) nearest to the subject vehicle. In each of several communications distance ranges, the several control information items includes a transmission rate and a transmission power with respect to each of the transmission time points or timing within a single control cycle (i.e., a single transmission sequence).

That is, the control information list is illustrated in FIG. 19, on the premise that (i) the control cycle or single transmission sequence is defined as being 800 ms, (ii) the distance with the closest vehicle is within a range of 100 to 200 m, and (iii) a reference timing is defined as the timing of 0 ms. At the timing of 0 ms, the data element is transmitted in the transmission power of 20 dBm and the transmission rate of 3 Mbps; at the timing of 200 ms, the data element is transmitted in the transmission power of 10 dBm and the transmission rate of 6 Mbps; at the timing of 400 ms, the data element is transmitted in the transmission power of 15 dBm and the transmission rate of 6 Mbps; at the timing of 600 ms, the data element is transmitted in the transmission power of 10 dBm and the transmission rate of 6 Mbps; and at the timing of 800 ms, returning to the reference timing of 0 ms, the data element is transmitted in the transmission power of 20 dBm and the transmission rate of 3 Mbps.

It is noted that as the distance to the closest vehicle is decreased, the transmission repetition times per single control cycle is increased. Further, the transmission rate and transmission power are set such that at each of the transmission time points, which are added in response to the decrease of the distance to the closest vehicle, the communications distance becomes short compared with other transmission time points.

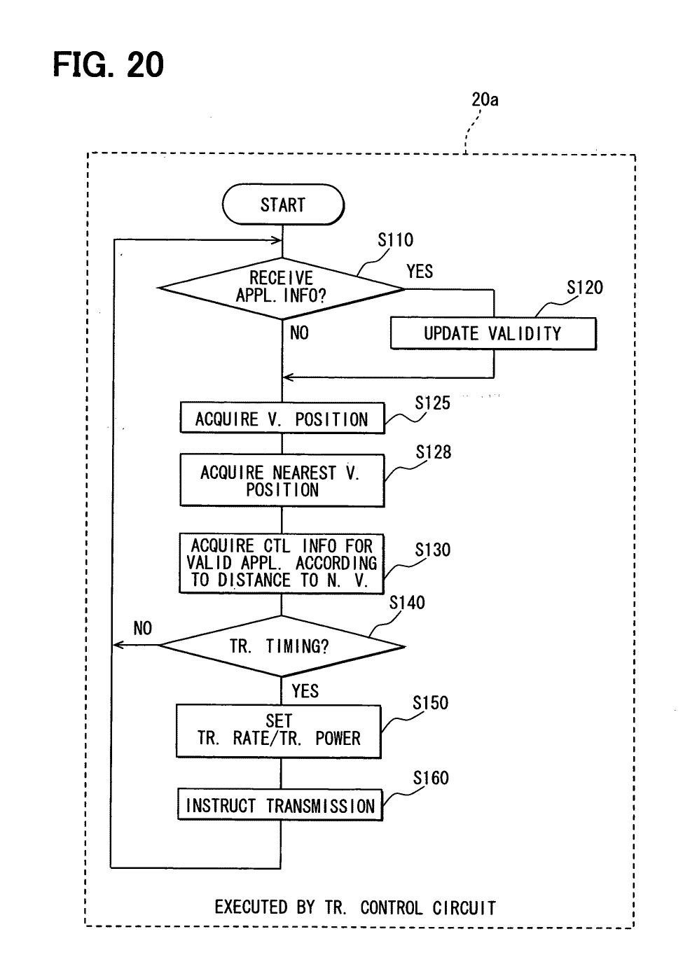

Furthermore, FIG. 20 illustrates a flowchart of an operation executed by the transmission control circuit 20 according to the third embodiment. The portion different from that of FIG. 11 of the second embodiment is in that (i) before acquiring the control information at S130, at S125 and S128, the position of the subject vehicle and the position of the closest vehicle are acquired from the subject vehicle information detection section 60 and the other vehicle information detection section 70, respectively; (ii) at S130, the distance between these vehicles is calculated from the acquired positions of the subject vehicle and closest vehicle; and (iii) when acquiring the control information among the valid application data elements included in the control information list, the control information corresponding to the calculated distance is acquired.

Under the transmission control circuit 20 according to the present embodiment, the transmission control can be made depending on the distance with other vehicles, helping prevent useless data transmission with the closest vehicle from taking place to thereby suppress the communications traffic amount.

For instance, in the second embodiment, within the speed range of 50 to 80 km/h, regardless of the distance to the closest vehicle, the data transmission is executed so as to reach only within the distance of 200 m from the subject vehicle. If the closest vehicle is located in a distance of 250 m from the subject vehicle, useless data transmission is made in the second embodiment. In contrast, according to the present third embodiment, such useless data transmission can be prevented from occurring.

Furthermore, in the present embodiment, the other vehicle information detection section 70 can be also referred to as an other vehicle information acquisition means or section.

(First Modification)

In the present third embodiment, with respect to the transmission control, the transmission timing and the transmission parameter (transmission rate and transmission power) are changed depending on the distance between the subject vehicle and the closest vehicle. Furthermore, the same technology as the second embodiment can be applied such that the transmission timing and the transmission parameter (transmission rate and transmission power) can be changed depending on (i) the distance with the closest vehicle and (ii) the speed of the subject vehicle.

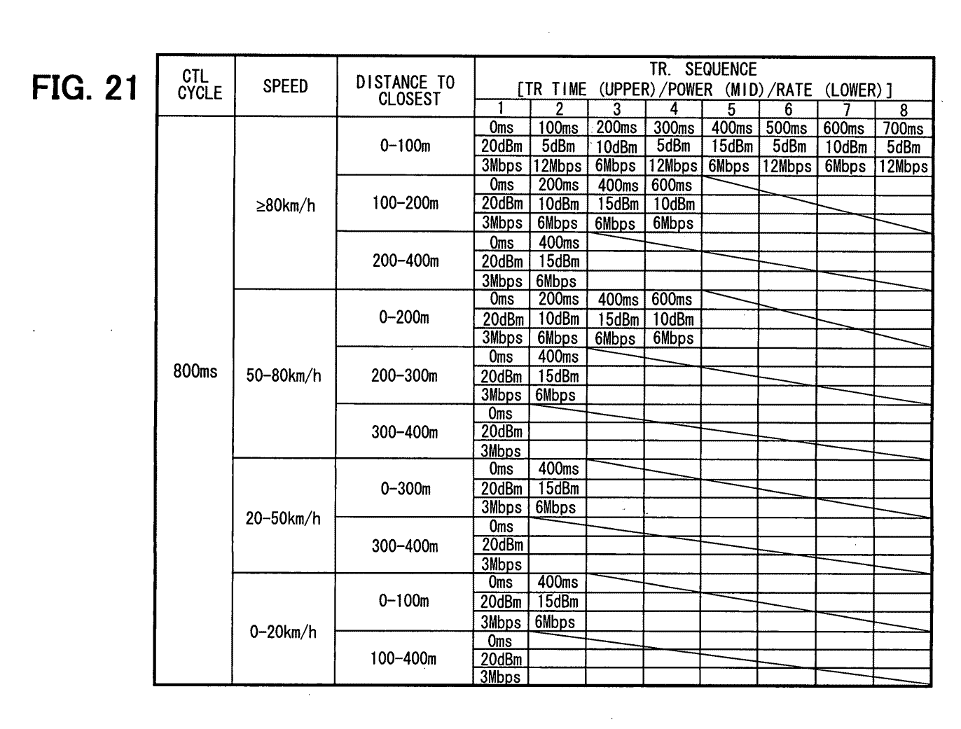

In such cases, the control information list stored in the storage section 30 can be configured as illustrated in FIG. 21, where the transmission timing and transmission parameter of the transmission control can be set depending on a combination of the distance to the closest vehicle and the speed of the subject vehicle.

Such a configuration allows the following: when another vehicle is close at high speed traveling of the subject vehicle, the information is transmitted in greater repetition times; when no vehicle is close even at high speed traveling of the subject vehicle, the information is transmitted in less repetition times. In addition, when another vehicle is close to the subject vehicle traveling at low speed, the repetition times in transmission can be reduced, allowing the communications traffic amount to be reduced.

Furthermore, in such cases, the operation of the transmission control circuit 20 includes acquisition of the speed of the subject vehicle when acquiring the position of the subject vehicle from the subject vehicle information detection section 60 at S125 illustrated in FIG. 20.

In addition, the third modification or the fourth modification of the first embodiment can be applied to the present third embodiment, thereby providing the similar effect.

Each or any combination of processes, steps, or means explained in the above can be achieved as a software section or unit (e.g., subroutine) and/or a hardware section or unit (e.g., circuit or integrated circuit), including or not including a function of a related device; furthermore, the hardware section or unit can be constructed inside of a microcomputer.

Furthermore, the software section or unit or any combinations of multiple software sections or units can be included in a software program, which can be contained in a computer-readable storage media or can be downloaded and installed in a computer via a communications network.

Aspects of the disclosure described herein are set out in the following clauses.

As an aspect of the disclosure, an in-vehicle communications apparatus in a vehicle is provided as follows. The in-vehicle communications apparatus is one of a plurality of communications apparatuses used for a wireless communications system in which the plurality of apparatuses execute broadcast type wireless data transmission with each other via a common wireless channel. The in-vehicle communications apparatus comprises a transmission unit and a transmission control circuit. The transmission unit is configured to perform a wireless transmission of transmission data by transforming the transmission data into a wireless transmission signal. The transmission control circuit is configured to periodically vary a communications distance of the transmission data by controlling a transmission parameter, which is used when the transmission unit performs the wireless transmission by transforming the transmission data into the wireless transmission signal.

According to the above configuration, the data transmission can be made in high repetition times with respect to a vehicle in a short distance from the subject vehicle; the data transmission can be made in low repetition times with respect to a vehicle in a long distance from the subject vehicle.

A conventional apparatus sets the transmission power (correlated with a communications distance) or transmission cycle to a predetermined fixed value according to a control condition such as a vehicle speed. Thus, compared with the conventional one, the in-vehicle communication apparatus according to the aspect of the present invention can secure the safety in vehicle traveling, and reduce the communications traffic amount of the wireless communications of the whole system, resulting in helping prevent the radio wave interference from arising.

As an optional aspect of the above apparatus, the transmission control circuit may be further configured to periodically vary the communications distance by controlling, as the transmission parameter, at least one of a transmission rate and a transmission power.

Under such a configuration, if the transmission rate is controlled by the transmission control circuit, the time occupancy ratio by the communications as well as the communications distance can be controlled. If the transmission power is controlled, the area to interfere with other data communications can be controlled.

As another optional aspect, the transmission control circuit may be further configured to include a storage section which stores a control pattern of the transmission parameter, varying periodically the communications distance of the transmission data by controlling the transmission parameter according to the control pattern stored in the storage section.

Under such a configuration, the communications distance and its change pattern of the transmission data can be set up in a discretionary manner or as needed by the control pattern stored in the storage section.

Further, in the above configuration, the storage section may store the control pattern of the transmission parameter with respect to each type of several types of the transmission data, the several types being different from each other. The transmission control circuit may be further configured to control the transmission parameter with respect to the each type of the several different types of the transmission data according to the control pattern stored in the storage section.

Under such a configuration, the communications distance and its change pattern of the transmission data can be set to the most appropriate values, for example, depending on the types of the transmission data such as vehicle information indicating a position or speed, driving operation information indicating a braking operation or accelerating operation by a driver. The communications distance and its periodic change pattern of the transmission data can be thus set up respectively depending on the types of the transmission data. It becomes possible to treat simultaneously the several transmission data which are generated by the several different application software programs.

As another optional aspect, the apparatus may further comprise a reception unit. The reception unit is configured to detect data transmission from an other communications apparatus included in the plurality of communications apparatuses based on a reception level of a reception signal, and output a carrier sense signal to the transmission unit when detecting the data transmission from the other communications apparatus, thereby prohibiting the transmission unit from performing the wireless transmission. The transmission control circuit may be further configured to control a determination value of the reception level such that as the communications distance of the transmission data periodically varied by the transmission control circuit becomes long, the determination value of the reception level used for the reception unit to detect the data transmission from the other communications apparatus becomes low.

That is, such a configuration allows a determination to determine vacancy of the wireless channel with a so-called carrier sense. When the wireless channel is vacant, the data transmission is permitted.

Under such a configuration, when the communications distance of the transmission data is short, a possibility of giving interference to other communications currently executed at a distant place is low, thus setting the determination value of the reception level to be high (i.e., degrading the reception sensitivity). In contrast, when the communications distance of the transmission data is long, a possibility of giving interference to other communications currently executed at a distant place is high, thus setting the determination value of the reception level to be low (i.e., upgrading the reception sensitivity).

Thus, the above configuration can help prevent occurrence of the following: starting the data transmission while data communications takes place in a proximity, thereby generating the radio wave interference; and stopping the data transmission regardless of generating no radio wave interference, thereby generating the delay in the data transmission.

As another optional aspect, the transmission control circuit may be further configured to periodically vary the communications distance of the transmission data by controlling the transmission parameter at each transmission timing at which the transmission data is inputted to the transmission unit from an in-vehicle device.

Under such a configuration, the transmission cycle of the transmission data can be controlled by an in-vehicle device, which inputs the transmission data to the transmission unit, using application software programs for generating transmission data.

Further, in the above configuration, a control information addition section may be provided in an in-vehicle device and configured to add control information to transmission data, which is outputted to the transmission unit. The control information is for indicating transmission parameter to control the communications distance of the transmission data. The transmission control circuit may be further configured to include a transmission parameter control section configured to extract the control information added to the transmission data, which is inputted into the transmission unit from the in-vehicle device, and control the transmission parameter of the transmission unit according to the extracted control information.

Under such a configuration, the communications distance of the transmission data can be controlled by an in-vehicle device, which inputs the transmission data to the transmission unit, using application software programs for generating transmission data.

As another optional aspect, a subject vehicle information acquisition section may be configured to acquire subject vehicle information including a speed of the vehicle as a subject vehicle. Herein, the transmission control circuit may be further configured to change the control pattern of the transmission parameter depending on the speed acquired by the subject vehicle information acquisition section.

Under such a configuration, varying of the communications distance periodically at the time of transmitting data transmission enables the setting up of the repetition times in transmission depending on not only a distance from the subject vehicle, but also a speed of the subject vehicle. Further, under the above configuration, unnecessary data transmission can be reduced more effectively depending on the speed of the subject vehicle, allowing the reduction of generating the radio wave interference.

Under the above configuration, the transmission control circuit may be further configured to perform a control of a transmission cycle such that the transmission cycle becomes short as the speed acquired by the subject vehicle information acquisition section becomes high, while varying the control pattern of the transmission parameter such that the communications distance of the transmission data becomes short at a transmission timing, which is added at a condition of high speed traveling of the subject vehicle by the control of the transmission cycle.

Under such a configuration, in an area near the subject vehicle, as the speed is increased, the data is transmitted with high repetition times. Conversely, it becomes difficult for the data to reach an area in a long distance. Therefore, according to the apparatus, while improving the safety during traveling of the vehicle, unnecessary data transmission can be reduced, helping prevent the generating of radio wave interference.

Further, in the above configuration, the transmission control circuit may be further configured to vary the control pattern of the transmission parameter such that as the speed acquired by the subject vehicle information acquisition section is high, the communications distance of the transmission data transmitted at each transmission timing becomes long.

Under such a configuration, at high speed traveling of the vehicle, compared with low speed traveling, the data can be transmitted to an area farther in a distance, thus raising the safety at the time of high speed driving.

As another optional aspect, a subject vehicle information acquisition section may be configured to acquire subject vehicle information including a position of the vehicle as a subject vehicle. Furthermore, an other vehicle information acquisition section may be configured to acquire other vehicle information including a position of an other vehicle. Herein, the transmission control circuit may be further configured to vary a transmission cycle of the transmission data and a control pattern of the transmission parameter depending on a relationship between the position of the subject vehicle acquired by the subject vehicle information acquisition section and the position of the other vehicle acquired by the other vehicle information acquisition section.

Under such a configuration, varying of the communications distance periodically at the time of transmitting data transmission enables setting up of the repetition times in transmission depending on not only a distance from the subject vehicle, but also a positional relationship between the subject vehicle and another vehicle. Thus, under such a configuration, the optimal data transmission can be made depending on the positional relationship between the subject vehicle and another vehicle, securely allowing the reduction of generating the radio wave interference.

Further, in the above configuration, the transmission control circuit may be further configured to perform a control of the transmission cycle such that the transmission cycle is short as a distance between the subject vehicle and a vehicle nearest the subject vehicle is short, while varying the control pattern of the transmission parameter such that the communications distance of the transmission data becomes short at a transmission timing, which is added when the distance between the subject vehicle and the vehicle nearest is short by the control of the transmission cycle.

Under such a configuration, the communications distance can be periodically changed based on the communications distance and transmission cycle, both of which are needed for the communications between the subject vehicle and the closest vehicle, helping prevent the data transmission with higher repetition times and broader communications range to thereby reduce the data communications traffic amount.

Further, additionally in the just preceding configuration, the subject vehicle information acquisition section may be further configured to acquire a speed of the subject vehicle as well as the position of the subject vehicle. The transmission control circuit may be further configured to perform a control of the transmission cycle such that the transmission cycle becomes short as a speed of the subject vehicle is high, varying the control pattern of the transmission parameter such that the communications distance of the transmission data becomes short at a transmission timing, which is added at a condition of high speed traveling of the subject vehicle by the control of the transmission cycle.

Under such a configuration, the transmission cycle and the communications distance can be controlled more appropriately based on the speed of the subject vehicle, and the distance between the subject vehicle and the closest vehicle, helping prevent the data transmission with higher repetition times and broader communication range to thereby reduce the data communications traffic amount.

It will be obvious to those skilled in the art that various changes may be made in the above-described embodiments of the present invention. However, the scope of the present invention should be determined by the following claims.

What is claimed:

1. An in-vehicle communications apparatus in a vehicle, the in-vehicle communications apparatus being one of a plurality of communications apparatuses used for a wireless communications system in which the plurality of apparatuses execute broadcast type wireless data transmission with each other via a common wireless channel,
the in-vehicle communications apparatus comprising:
a transmission unit configured to perform a wireless transmission of transmission data by transforming the transmission data into a wireless transmission signal; and
a transmission control circuit configured to periodically vary a communications distance of the transmission data by controlling a transmission parameter, which is used when the transmission unit performs the wireless transmission by transforming the transmission data into the wireless transmission signal.

2. The in-vehicle communications apparatus according to claim 1,
the transmission control circuit being further configured to periodically vary the communications distance by controlling, as the transmission parameter, at least one of a transmission rate and a transmission power.

3. The in-vehicle communications apparatus according to claim 1,
the transmission control circuit being further configured to include a storage section which stores a control pattern of the transmission parameter, varying periodically the communications distance of the transmission data by controlling the transmission parameter according to the control pattern stored in the storage section.

4. The in-vehicle communications apparatus according to claim 3, wherein
the storage section stores the control pattern of the transmission parameter with respect to each type of several types of the transmission data, the several types being different from each other,
the transmission control circuit being further configured to control the transmission parameter with respect to the each type of the several different types of the transmission data according to the control pattern stored in the storage section.

5. The in-vehicle communications apparatus according to claim 1, further comprising:
a reception unit configured to
detect data transmission from an other communications apparatus included in the plurality of communications apparatuses based on a reception level of a reception signal, and
output a carrier sense signal to the transmission unit when detecting the data transmission from the other communications apparatus, thereby prohibiting the transmission unit from performing the wireless transmission,
the transmission control circuit being further configured to control a determination value of the reception level such that as the communications distance of the transmission data periodically varied by the transmission control circuit becomes long, the determination value of the reception level used for the reception unit to detect the data transmission from the other communications apparatus becomes low.

6. The in-vehicle communications apparatus according to claim 1,
the transmission control circuit being further configured to periodically vary the communications distance of the transmission data by controlling the transmission parameter at each transmission timing at which the transmission data is inputted to the transmission unit from an in-vehicle device.

7. The in-vehicle communications apparatus according to claim 6, further comprising:
a control information addition section provided in an in-vehicle device and configured to add control information to transmission data, which is outputted to the transmission unit, the control information indicating transmission parameter to control the communications distance of the transmission data,
the transmission control circuit being further configured to include a transmission parameter control section configured to extract the control information added to the transmission data, which is inputted into the transmission unit from the in-vehicle device, and control the transmission parameter of the transmission unit according to the extracted control information.

8. The in-vehicle communications apparatus according to claim 1, further comprising:
a subject vehicle information acquisition section configured to acquire subject vehicle information including a speed of the vehicle as a subject vehicle,
the transmission control circuit being further configured to change the control pattern of the transmission parameter depending on the speed acquired by the subject vehicle information acquisition section.

9. The in-vehicle communications apparatus according to claim 8,
the transmission control circuit being further configured to perform a control of a transmission cycle such that the transmission cycle becomes short as the speed acquired by the subject vehicle information acquisition section becomes high, while varying the control pattern of the transmission parameter such that the communications distance of the transmission data becomes short at a transmission timing, which is added at a condition of high speed traveling of the subject vehicle by the control of the transmission cycle.

10. The in-vehicle communications apparatus according to claim 8,
the transmission control circuit being further configured to vary the control pattern of the transmission parameter such that as the speed acquired by the subject vehicle information acquisition section is high, the communications distance of the transmission data transmitted at each transmission timing becomes long.

11. The in-vehicle communications apparatus according to claim 1, further comprising:
a subject vehicle information acquisition section configured to acquire subject vehicle information including a position of the vehicle as a subject vehicle; and
an other vehicle information acquisition section configured to acquire other vehicle information including a position of an other vehicle,
the transmission control circuit being further configured to vary a transmission cycle of the transmission data and a control pattern of the transmission parameter depending on a relationship between the position of the subject vehicle acquired by the subject vehicle information acquisition section and the position of the other vehicle acquired by the other vehicle information acquisition section.

12. The in-vehicle communications apparatus according to claim 11,
the transmission control circuit being further configured to perform a control of the transmission cycle such that the transmission cycle is short as a distance between the subject vehicle and a vehicle nearest the subject vehicle is short, while varying the control pattern of the transmission parameter such that the communications distance of the transmission data becomes short at a transmission timing, which is added when the distance between the subject vehicle and the vehicle nearest is short by the control of the transmission cycle.

13. The in-vehicle communications apparatus according to claim 12,
the subject vehicle information acquisition section being further configured to acquire a speed of the subject vehicle as well as the position of the subject vehicle,
the transmission control circuit being further configured to perform a control of the transmission cycle such that the transmission cycle becomes short as a speed of the subject vehicle is high, varying the control pattern of the transmission parameter such that the communications distance of the transmission data becomes short at a transmission timing, which is added at a condition of high speed traveling of the subject vehicle by the control of the transmission cycle.
